(19) United States
(12) Patent Application Publication
(10) Pub. No.: US 2025/0026964 A1
(43) Pub. Date: Jan. 23, 2025

(54) DECORATIVE FILM WITH COVER FILM AND METHOD FOR MANUFACTURING SAME AND METHOD FOR MOUNTING SAME

(71) Applicant: 3M INNOVATIVE PROPERTIES COMPANY, St. Paul, MN (US)

(72) Inventors: Akihiko Nakayama, Shizuoka (JP); Hiroki Suzuki, Yamagata (JP); Masafumi Hosoume, Yamagata (JP); Seigo Ishikawa, Yamagata (JP)

(21) Appl. No.: 18/713,852

(22) PCT Filed: Nov. 29, 2022
(86) PCT No.: PCT/IB2022/061548

§ 371 Date: May 28, 2024

(30) Foreign Application Priority Data
Nov. 30, 2021 (JP) 2021-194381

(51) Int. Cl. C09J 7/25; C08J 3/28; C08J 7/04; C09J 133/06

(52) U.S. Cl. CPC C09J 7/255; C08J 3/28; C08J 7/042; C09J 133/064; C08J 2333/08; C08J 2367/06; C08J 2375/04; C09J 2301/12; C09J 2301/302; C09J 2301/416; C09J 2467/001; C09J 2475/008

(57) ABSTRACT

A decorative film with a cover film of an embodiment includes: (a) a polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane: (b) a removable cover film having a corona treated or plasma treated surface, wherein the corona treated or plasma treated surface of the removable cover film is in contact with the first surface of the polyurethane layer: (c) a base layer having a first surface and a second surface opposite to the first surface, wherein the first surface of the base layer is in contact with the second surface of the polyurethane layer; and (d) an adhesive layer in contact with the second surface of the base layer.

The present disclosure relates to a decorative film with a cover film, and a method for manufacturing the decorative film and a method mounting the decorative film.

### BACKGROUND

It is known that an appearance of a vehicle body, a part, or the like of a car is decorated by attaching a decorative film thereto instead of painting.

Patent Document 1 (JP 2013-039724 A) discloses “a vehicle paint replacement film comprising a transparent material layer and a coloring adhesive layer, the coloring adhesive layer comprising: (i) a colorant premix comprising (a) an acrylic polyol and (b) a colorant dispersed in the acrylic polyol, the colorant selected from the group consisting of a combination of an organic pigment and an inorganic pigment, a combination of an organic pigment and an aluminum photoluminescent material, a combination of an organic pigment and a mica photoluminescent material, a combination of an inorganic pigment and an aluminum photoluminescent material, a combination of an inorganic pigment and a mica photoluminescent material, a combination of an aluminum photoluminescent material and a mica photoluminescent material, and combinations thereof; and (ii) an adhesive polymer; wherein a solid content ratio by mass represented by (adhesive polymer)/(adhesive polymer+acrylic polyol) is 25% or more”.

Patent Document 2 (JP 2007-297569 A) discloses “a decorative layer-forming film comprising: a top coat layer comprising a polyurethane resin; and a carrier film provided on a surface side of the top coat layer, wherein the polyurethane resin comprises a polyurethane resin composition comprising: (1) a polyisocyanate containing 0.5 equivalents or more of an isocyanurate or adduct body of isophorone diisocyanate or both thereof, based on the total polyisocyanate; and (2) a polyol comprising a caprolactone diol, a polycarbonate diol, or a mixture thereof, and containing 0.4 equivalents or more of a polyester polyol with an average molecular weight of 1000 or less, based on the total polyol, and an equivalent ratio between the polyisocyanate and the polyol is from 0.7 to 2.0”.

### SUMMARY

A cured product of a reactive polyurethane composition has excellent durability, and thus can be advantageously used as a surface layer (top layer) of a decorative film for exterior applications. However, when a surface layer is formed using a reactive polyurethane composition, a problem, such as a crater-like defect (indentation), can occur in the appearance of the decorative film. The reactive polyurethane composition is generally not completely cured only by heat treatment during a step of forming the surface layer of the decorative film, and the curing reaction of the polyurethane continues and proceeds gradually after heat treatment. When a decorative film or an intermediate member having a surface layer is wound as a roll after the heat treatment, air may be trapped between layers of the wound decorative films or of the intermediate members. It is considered that a soft surface layer which is not completely cured is compressed by the trapped air, resulting in occurrence of a crater-like defect on the surface layer.

With reference to FIGS. 3A to 3D, a mechanism in which a crater defect occurs in the manufacture of a decorative film is described. A schematic cross-sectional view of an intermediate member of a decorative film is shown in FIG. 3A. An intermediate member 30a is a laminate having a cover film 12a, a polyurethane layer 14a that serves as a surface layer of the decorative film, a base layer 16a, and a process film 32a that supports the base layer 16a. The cover film 12a is laminated for the purpose of protecting the polyurethane layer 14a having a soft surface which is not completely cured.

The intermediate member 30a is temporarily wound into a roll and stored until a subsequent step. FIG. 3B shows a schematic cross-sectional view of the intermediate member wound into a roll and stacked. When the intermediate member is wound into a roll, air 40 is trapped between a process film 32b of an upper intermediate member 30b and the cover film 12a of the lower intermediate member 30a. The polyurethane layer 14a having a soft surface that is not completely cured is compressed and deformed via the cover film 12a by the air 40, and a crater 42 is formed on the polyurethane layer 14a.

After formation of an adhesive layer in another step, the intermediate member is unwound from the roll, the process film is removed, and an adhesive layer is laminated over the base layer. FIG. 3C shows a schematic cross-sectional view of a decorative film with a cover film, in which an adhesive layer is laminated. In a decorative film with a cover film 10a, an adhesive layer 18a is laminated over a lower surface of a base film 16a of the intermediate member. The adhesive layer 18a is protected by a liner 20a. In the decorative film with a cover film 10a, the cover film 12a is restored to its original shape due to its rigidity, but the polyurethane layer 14a is completely cured in a deformed state, and the crater 42 remains intact.

Thereafter, the cover film is removed from the decorative film with a cover film during mounting. FIG. 3D shows a schematic cross-sectional view of the decorative film with the cover film removed. The crater 42 formed on the polyurethane layer 14a of the decorative film is visually recognized as a defect of the decorative film surface.

Examples of methods for preventing or suppressing the occurrence of craters include allowing a curing reaction of a reactive polyurethane composition to proceed further during heat treatment to increase a hardness of a polyurethane layer. Examples of means for allowing the curing reaction of the reactive polyurethane composition to proceed further include increasing a temperature for the heat treatment, increasing a time of the heat treatment (e.g., lowering a line speed of a continuous oven), and increasing an amount of a catalyst to be used.

However, when the hardness of the polyurethane layer is increased, tackiness of a surface of the polyurethane layer may decrease until the cover film is laminated over the polyurethane layer, and the cover film may not adhere well to the surface of the polyurethane layer. If the adhesion of the cover film is poor, the cover film may come apart from the decorative film during manufacture, transportation, or use of the decorative film.

The present disclosure provides a decorative film with a cover film, which includes a polyurethane layer as a surface layer and has few defects such as craters and high surface quality.

### SUMMARY OF EMBODIMENTS

According to an embodiment of the present disclosure, there is provided a decorative film with a cover film including:
(a) a polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane;
(b) a removable cover film having a corona treated or plasma treated surface, wherein the corona treated or plasma treated surface of the removable cover film is in contact with the first surface of the polyurethane layer;
(c) a base layer having a first surface and a second surface opposite to the first surface, wherein the first surface of the base layer is in contact with the second surface of the polyurethane layer; and
(d) an adhesive layer in contact with the second surface of the base layer.

According to another embodiment of the present disclosure, there is provided a method for manufacturing a decorative film with a cover film, including:
(a) providing a base layer having a first surface and a second surface opposite to the first surface;
(b) forming a polyurethane layer on the first surface of the base layer, the polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane, and the first surface of the base layer is in contact with the second surface of the polyurethane layer;
(c) providing a removable cover film;
(d) treating a surface of the removable cover film with corona or plasma;
(e) laminating the removable cover film over the polyurethane layer such that the corona treated or plasma treated surface of the removable cover film contacts the first surface of the polyurethane layer; and
(f) forming an adhesive layer on the second surface of the base layer to obtain a decorative film with a cover film.

According to yet another embodiment of the present disclosure, there is provided a method for manufacturing a decorative film, including:
(a) providing a base layer having a first surface and a second surface opposite to the first surface;
(b) forming a polyurethane layer on the first surface of the base layer, the polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane and the first surface of the base layer is in contact with the second surface of the polyurethane layer;
(c) providing a removable cover film;
(d) treating a surface of the removable cover film with corona or plasma;
(e) laminating the removable cover film over the polyurethane layer such that the corona treated or plasma treated surface of the removable cover film contacts the first surface of the polyurethane layer;
(f) forming an adhesive layer on the second surface of the base layer; and
(h) removing the removable cover film from the first surface of the polyurethane layer.

According to yet another embodiment of the present disclosure, there is provided a method for mounting a decorative film, including: applying the decorative film with a cover film described above to a substrate; and thereafter, removing the removable cover film from the first surface of the polyurethane layer.

According to yet another embodiment of the present disclosure, there is provided a method for mounting a decorative film, including: removing the removable cover film of the decorative film with a cover film described above from the first surface of the polyurethane layer to obtain a decorative film; and applying the decorative film to a substrate.

### Advantageous Effects of Invention

The present disclosure can provide a decorative film with a cover film, which includes a polyurethane layer as a surface layer and has few defects such as craters and high surface quality.

The above description should not be construed as disclosing all embodiments of the present invention and all advantages relating to the present invention.

### BRIEF DESCRIPTION OF DRAWINGS

FIG. 1 is a schematic cross-sectional view of a decorative film with a cover film of an embodiment.

FIG. 2 is a schematic cross-sectional view of a decorative film with a cover film of another embodiment.

FIG. 3A is an explanatory diagram of a mechanism in which a crater defect occurs in the manufacture of a decorative film.

FIG. 3B is an explanatory diagram of the mechanism in which a crater defect occurs in the manufacture of the decorative film.

FIG. 3C is an explanatory diagram of the mechanism in which a crater defect occurs in the manufacture of the decorative film.

FIG. 3D is an explanatory diagram of the mechanism in which a crater defect occurs in the manufacture of the decorative film.

### DESCRIPTION OF EMBODIMENTS

Hereinafter, representative embodiments of the present invention will be described in more detail with reference to the drawings, as necessary, for the purpose of illustration, but the present invention is not limited to these embodiments.

In the present disclosure, the term “(meth)acrylic” refers to acrylic or methacrylic, and the term “(meth)acrylate” refers to acrylate or methacrylate.

In the present disclosure, “curing” also encompasses a concept commonly referred to as “cross-link”.

In the present disclosure, the term “film” encompasses articles referred to as “sheets”

In the present disclosure, the term “transparent” refers to an average transmittance of approximately 80% or greater, preferably approximately 85% or greater or approximately 90% or greater, in the visible light range (wavelengths from 400 nm to 700 nm), measured in accordance with JIS K 7375:2008. An upper limit of the average transmittance is not particularly limited, and can be, for example, less than approximately 100%, approximately 99% or less, or approximately 98% or less.

In the present disclosure, the term “translucent” refers to an average transmittance of approximately 40% or more and less than approximately 80%, preferably approximately 75% or less, in the visible light range (wavelengths from 400 nm to 700 nm), measured in accordance with JIS K 7375.

A decorative film with a cover film according to an embodiment includes:
(a) a polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane;
(b) a removable cover film having a corona treated or plasma treated surface, wherein the corona treated or plasma treated surface of the removable cover film is in contact with the first surface of the polyurethane layer;
(c) a base layer having a first surface and a second surface opposite to the first surface, wherein the first surface of the base layer is in contact with the second surface of the polyurethane layer; and
(d) an adhesive layer in contact with the second surface of the base layer.

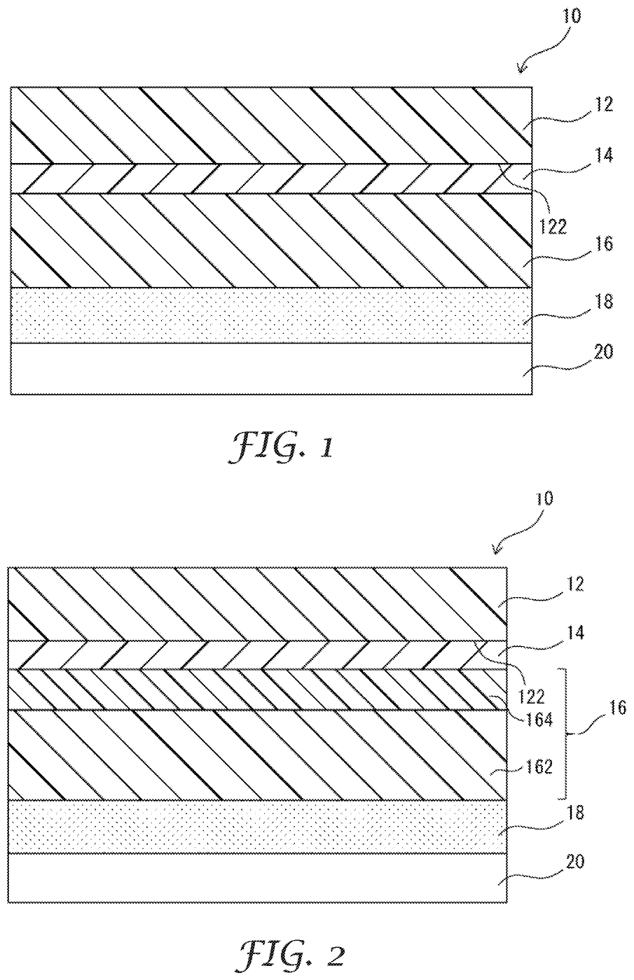

FIG. 1 illustrates a schematic cross-sectional view of a decorative film with a cover film of an embodiment. A decorative film with a cover film 10 includes a removable cover film 12, a polyurethane layer 14, a base layer 16, and an adhesive layer 18. A corona treated or plasma treated surface 122 of the removable cover film 12 is in contact with a first surface (upper surface in FIG. 1) of the polyurethane layer 14. A first surface (upper surface in FIG. 1) of the base layer 16 is in contact with a second surface (lower surface in FIG. 1) of the polyurethane layer 14. The adhesive layer 18 is in contact with a second surface (lower surface in FIG. 1) of the base layer 16. The decorative film with a cover film 10 may further include a liner 20 as an optional element.

The polyurethane layer contains a polyurethane that is crosslinked at least partially. The polyurethane that is crosslinked at least partially includes at least one of a polyester-based polyurethane or a polycarbonate-based polyurethane. In the present disclosure, “partially crosslinked” means a state where some of reaction sites of a polyol and of reaction sites of a crosslinking agent, the reaction sites participating in a crosslinking reaction, react to form crosslinks, but reaction sites capable of the crosslinking reaction still remain for both the polyol and the crosslinking agent. On the other hand, “completely crosslinked” means a state where at least one of the reaction site of the polyol or the reaction site of the crosslinking agent, the reaction sites participating in a crosslinking reaction, is completely consumed by the crosslinking reaction, or a state where crosslinking of the polyurethane has proceeded to a greater degree, and, as a result, the reaction site is no longer capable of participating in the crosslinking reaction. For example, in a reactive polyurethane composition in which an equivalent ratio between a polyol and an isocyanate crosslinking agent (NCO/OH) is less than 1, even if a hydroxyl group of the polyol remains, the polyurethane is completely crosslinked as long as an isocyanate group of the isocyanate crosslinking agent is completely consumed.

The polyurethane layer can be formed, for example, by coating a polyurethane layer composition such as a reactive polyurethane composition onto the first surface of the base layer or the liner with knife coating, bar coating, blade coating, doctor coating, roll coating, cast coating, or the like, and heating the composition, as necessary. The polyurethane layer formed on the liner can be hot-laminated or transferred and laminated (if the first surface of the base layer is adhesive to the polyurethane layer) over the base layer such that the second surface of the polyurethane layer contacts the first surface of the base layer. A heating temperature can be, for example, approximately 40° C. or higher, approximately 50° C. or higher, or approximately 60° C. or higher, and approximately 140° C. or lower, approximately 120° C. or lower, or approximately 100° C. or lower. A heating time can be, for example, approximately 1 minute or longer, approximately 2 minutes or longer, or approximately 5 minutes or longer, and approximately 1 hour or shorter, approximately 30 minutes or shorter, or approximately 20 minutes or shorter.

The reactive polyurethane composition may be one-component curable (moisture curable type, blocked isocyanate type, or the like) or may be two-component curable. In an embodiment, the reactive polyurethane composition is a two-component curable composition containing a polyol and an isocyanate crosslinking agent.

Examples of the polyol include polyester polyols such as condensates of a polycaprolactone diol, a polycaprolactone triol, or a low molecular weight polyol having 2 to 20 carbon atoms and an aliphatic polyvalent carboxylic acid or an aromatic polyvalent carboxylic acid (for example, polyethylene adipate, polypropylene adipate, polybutylene adipate, polyhexamethylene adipate, and polybutylene sebacate); and polycarbonate polyols such as polybutylene carbonate, polyhexamethylene carbonate, poly (3-methyl-1,5-pentylene) carbonate, poly (1,4-dimethylcyclohexylene) carbonate, polydiethylene glycol carbonate, polytetraethylene glycol carbonate, and polydipropylene glycol carbonate. Polyester-based polyurethanes are formed from the polyester polyols. Polycarbonate-based polyurethanes are formed from the polycarbonate polyols.

Examples of the low molecular polyol having from 2 to 20 carbon atoms constituting the polyester polyol include ethylene glycol, 1,2-propanediol, 1,3-propanediol, 2-methyl-1,3-propanediol, 2-butyl-2-ethyl-1,3-propanediol, 1,3-butanediol, 1,4-butanediol, 1,5-pentanediol, 3-methyl-1,5-pentanediol, 1,6-hexanediol, neopentyl glycol, glycerin, diethylene glycol, trimethylene glycol, triethylene glycol, tetraethylene glycol, dipropylene glycol, tripropylene glycol, cyclohexanedimethanol, and methylpentanediol adipate.

The polyol may further include, as optional components, the low molecular weight polyol having 2 to 20 carbon atoms described above; (meth)acrylic polyols that are copolymers of hydroxyl-free (meth)acrylates such as methyl (meth)acrylate, n-butyl (meth)acrylate, 2-ethylhexyl (meth)acrylate, and ethylene glycol (meth)acrylic acid diester with hydroxy hydroxyl group-containing (meth)acrylates such as 2-hydroxyethyl (meth)acrylate and ethylene glycol methacrylic acid monoester; and polyether polyols such as polyethylene glycol, polypropylene glycol, polytetramethylene glycol, propylene oxide adducts thereof, propylene oxide adducts of glycerin, propylene oxide adducts of saccharides such as sorbitol and sucrose, and propylene oxide adducts of compounds having active hydrogen such as ethylenediamine.

The polyol may be used alone, or a combination of two or more types of polyols may be used.

Examples of the isocyanate crosslinking agent include aliphatic polyisocyanates such as 1,6-hexamethylene diisocyanate, 2,2,4-trimethylhexamethylene diisocyanate, 2,4,4-trimethylhexamethylene diisocyanate, and lysine diisocyanate: alicyclic polyisocyanates such as isophorone diisocyanate, trans- and/or cis-1,4-cyclohexanediisocyanate, norbornene diisocyanate, and 4,4′-methylenebis cyclohexyl diisocyanate (also called hydrogenated MDI, H12MDI, etc.); aromatic polyisocyanates such as 2,4-tolylene diisocyanate, 2,6-tolylene diisocyanate, methylenebis(4-phenylisocyanate), 2,4′-diphenylmethane diisocyanate, and 2,2′-diphenylmethane diisocyanate; and burette modified products, isocyanurate modified products, carbodiimide modified products or adduct modified products thereof. The isocyanate crosslinking agent may be used alone, or a combination of two or greater types of isocyanate crosslinking agents may be used.

An equivalent ratio between the polyol and the isocyanate crosslinking agent (NCO/OH) can be approximately 0.5 or greater, approximately 0.7 or greater, or approximately 0.9 or greater and approximately 2.5 or less, approximately 2.0 or less, or approximately 1.5 or less.

The reactive polyurethane composition may contain a catalyst. Examples of the catalyst include dibutyltin dilaurate (DBTDL), zinc naphthenate, zinc octenoate, and triethylenediamine. An amount of the catalyst to be used is typically approximately 0.005 parts by mass or greater and approximately 0.5 parts by mass or less, per 100 parts by mass of a total of the polyol and the isocyanate crosslinking agent.

The reactive polyurethane composition may be aqueous or organic solvent-based. In a case where the reactive polyurethane composition is aqueous, the composition can be further cross-linked with a polycarbodiimide, an aziridine, an oxazoline, or the like. The aqueous reactive polyurethane composition preferably includes a combination of polycarbonate polyol with a polycarbodiimide, 4,4′-methylenebis(cyclohexyl diisocyanate) and/or an aziridine. The organic solvent-based reactive polyurethane composition preferably includes a combination of a polycaprolactone diol and a polycarbonate diol with an isophorone diisocyanate trimer (isocyanurate).

The polyurethane layer may contain, as necessary, additives, e.g., ultraviolet absorbents such as benzotriazole, Tinuvin (trade name) 99-2 (BASF Japan Ltd., Chuo-ku, Tokyo, Japan), and Tinuvin (trade name) 1130 (BASF Japan Ltd.), and hindered amine light stabilizers (HALS) such as Tinuvin (trade name) 292 (BASF Japan Ltd.). The use of ultraviolet absorbers or hindered amine light stabilizers can effectively prevent discoloration, fading, deterioration, and the like when the base layer includes a decorative layer or a colorant. The polyurethane layer may contain a hard coating material, a gloss-imparting agent, and the like. For providing an intended appearance, the polyurethane layer may be transparent or translucent. The polyurethane layer is advantageously transparent.

The polyurethane layer may have a variety of thicknesses, but generally has a thickness of approximately 1 μm or greater, approximately 5 μm or greater, or approximately 10 μm or greater, and approximately 100 μm or less, approximately 80 μm or less, or approximately 60 μm or less. When the decorative film is applied to an article with a complex shape, from the perspective of shape conformability, a thin polyurethane layer is advantageous. For example, the thickness is desirably approximately 80 μm or less or approximately 60 μm or less. Alternatively, in a case where high light resistance or weather resistance is imparted to an article, a thick polyurethane layer is advantageous. Desirably, for example, the thickness is approximately 5 μm or greater or approximately 10 μm or greater.

The decorative film with a cover film is required to have a well-balanced characteristics between the adhesiveness of the removable cover film to the polyurethane layer (that is, the cover film does not come off during manufacture of, transportation of, or operation for the decorative film with a cover film) and the peelability of the removable cover film (that is, the cover film can be easily removed during or after mounting of the decorative film with a cover). In the present disclosure, corona treatment or plasma treatment is performed on a surface of the removable cover film as a means for achieving such a balance.

The removable cover film protects the surface of the polyurethane layer for a period of time until the polyurethane contained in the polyurethane layer is completely crosslinked, and further during manufacture, transportation, or use of the decorative film or transfers the smooth surface of the removable cover film to such a polyurethane layer, and thus contributes to enhancement of the surface quality of the polyurethane layer. The removable cover film can also be utilized as a support during manufacture, transportation, or use of the decorative film.

Resin films of polyvinyl chlorides, polyolefins such as polyethylene and polypropylene, acrylic resins, polyesters such as polyethylene terephthalate and polybutylene terephthalate, or fluorinated polymers can be used as the removable cover film.

The removable cover film is preferably a polyethylene terephthalate film. The polyethylene terephthalate film can effectively prevent damage to the polyurethane layer and maintain or improve the surface quality of the polyurethane layer.

Advantageously, the polyethylene terephthalate film is a biaxially stretched polyethylene terephthalate film. The biaxially stretched polyethylene terephthalate film has high elongation at break and tensile strength, and thus it is possible to effectively prevent damage to the polyurethane layer and maintain or improve the surface quality of the polyurethane layer.

The surface of the removable cover film, which contacts the first surface of the polyurethane layer, is subjected to corona treatment or plasma treatment. The corona treatment and the plasma treatment can impart, to the removable cover film, such adhesiveness that, during manufacture, transportation, and use of the decorative film with a cover film, the cover film does not come off from a polyurethane layer containing a polyurethane in which crosslinking has relatively advanced during formation of the polyurethane layer, and that, during mounting of the decorative film with a cover film, the cover film can be removed from the polyurethane layer.

In an embodiment, the corona treatment and the plasma treatment can clean the surface of the removable cover film. Thus, foreign materials trapped between the removable cover film and the polyurethane layer can be reduced or eliminated, and, as a result, the surface quality of the polyurethane layer can be further enhanced.

In an embodiment, the corona treatment and the plasma treatment can remove static electricity charged on the surface of the removable cover film, the static electricity caused by unwinding of the removable cover film from a roll, and can prevent dust and other foreign materials from adhering to the surface of the removable cover film. Thus, foreign materials trapped between the removable cover film and the polyurethane layer can be reduced or eliminated, and, as a result, the surface quality of the polyurethane layer can be further enhanced.

The corona treatment can be performed using a corona treatment apparatus commonly used for surface modification of a resin film. Examples of the corona treatment apparatus include GXR50 (Sherman Treaters Ltd., Thame, Oxfordshire, England) and TEG-4AX (KASUGA DENKI, INC., Kawasaki-shi, Kanagawa, Japan). Conditions for the corona treatment are not particularly limited. For example, an applied power can be from 1 kW to 5 KW, a corona treatment time can be from 0.05 seconds to 5 seconds, and a frequency can be from 10 kHz to 20 kHz. Discharge during the corona treatment may be continuous or intermittent.

The plasma treatment can be performed using a plasma treatment apparatus commonly used for surface modification of a resin film. Examples of the plasma treatment apparatus include atmospheric pressure plasma treatment apparatuses and vacuum plasma apparatuses. Conditions for the plasma treatment are not particularly limited. For example, a plasma gas can be a nitrogen gas or a noble gas such as helium or argon, a power can be from 0.5 kW to 4 kW, a supply amount of the plasma gas can be from 50 liters per minute to 150 liters per minute, a pressure in the plasma treatment apparatus can be atmospheric pressure, and a plasma treatment time can be from 0.05 seconds to 5 seconds.

A surface tension of the corona treated or plasma treated surface of the removable cover film is preferably approximately 40 mN/m or greater. The surface tension is more preferably approximately 44 mN/m or greater, or approximately 46 mN/m or greater. Generally, the surface tension of the corona treated or plasma treated surface of the removable cover film is preferably approximately 60 mN/m or less. The surface tension is more preferably approximately 58 mN/m or less, or approximately 56 mN/m or less.

The surface of the removable cover film opposite to the corona treated or plasma treated surface may not have corona treatment or plasma treatment. In an embodiment, a surface tension of the surface of the removable cover film opposite to the corona treated or plasma treated surface is less than approximately 40 mN/m, approximately 39 mN/m or less, or approximately 38 mN/m or less.

The corona treated or plasma treated surface of the removable cover film may be surface-processed for transferring the shape to the surface of the polyurethane layer. Examples of surface processing include matte processing, embossing, and sandblasting. The surface of the removable cover film opposite to the corona treated or plasma treated surface may be subjected to surface treatment to impart slipperiness, peelability, and the like.

A thickness of the removable cover film may be, for example, approximately 5 μm or greater, approximately 10 μm or greater, or approximately 25 μm or greater, and may be 150 μm or less, 100 μm or less, or 80 μm or less.

Resin films of polyurethanes, polyvinyl chlorides, polyolefins such as polyethylene and polypropylene, acrylic resins, polyesters such as polyethylene terephthalate and polybutylene terephthalate, or fluorinated polymers can be used as the base layer. The base layer preferably includes at least one thermoplastic resin selected from the group consisting of a polyurethane, a polyvinyl chloride, a polyolefin, an acrylic resin, and a polyester. In this embodiment, the decorative film can be mounted to an article having a curved surface manually, with the use of a vacuum/air pressure molding (Dual Vacuum Thermoforming [DVT]) method or a vacuum molding (Vacuum Thermoforming [VT]) method with excellent shape conformability.

The base layer may be colored. Examples of the colorant include organic pigments, inorganic pigments, aluminum photoluminescent materials, and mica photoluminescent materials, and blends of two or more types thereof. The colorant is preferably selected from the group consisting of: combinations of organic pigments and inorganic pigments; combinations of organic pigments and aluminum photoluminescent materials; combinations of organic pigments and mica photoluminescent materials; combinations of inorganic pigments and aluminum photoluminescent materials; combinations of inorganic pigments and mica photoluminescent materials; and combinations of aluminum photoluminescent materials and mica photoluminescent materials; and combinations thereof. The use of the combinations of colorants described above allows decorative films with various types of color tones to be obtained, thereby allowing high design requirements to be met.

Examples of the organic pigments include phthalocyanine-based pigments such as phthalocyanine blue and phthalocyanine green, azo lake-based pigments, indigo-based pigments, perinone-based pigments, perylene-based pigments, quinophthalone-based pigments, dioxazine-based pigments, and quinacridone-based pigments such as quinacridone red. Examples of the inorganic pigments include titanium dioxide, yellow lead, yellow iron oxide, colcothar, red iron oxide, and carbon black. Examples of the aluminum photoluminescent materials include aluminum flakes, vapor-deposited aluminum flakes, metal oxide-coated aluminum flakes, and colored aluminum flakes. Examples of the mica photoluminescent materials include flake-like mica coated with a metal oxide such as titanium dioxide or iron oxide, and synthetic mica.

A content of the colorant can be approximately 1 mass % or greater, approximately 2 mass % or greater, or approximately 5 mass % or greater, and approximately 80 mass % or less, approximately 75 mass % or less, or approximately 66 mass % or less, based on the mass of the base layer.

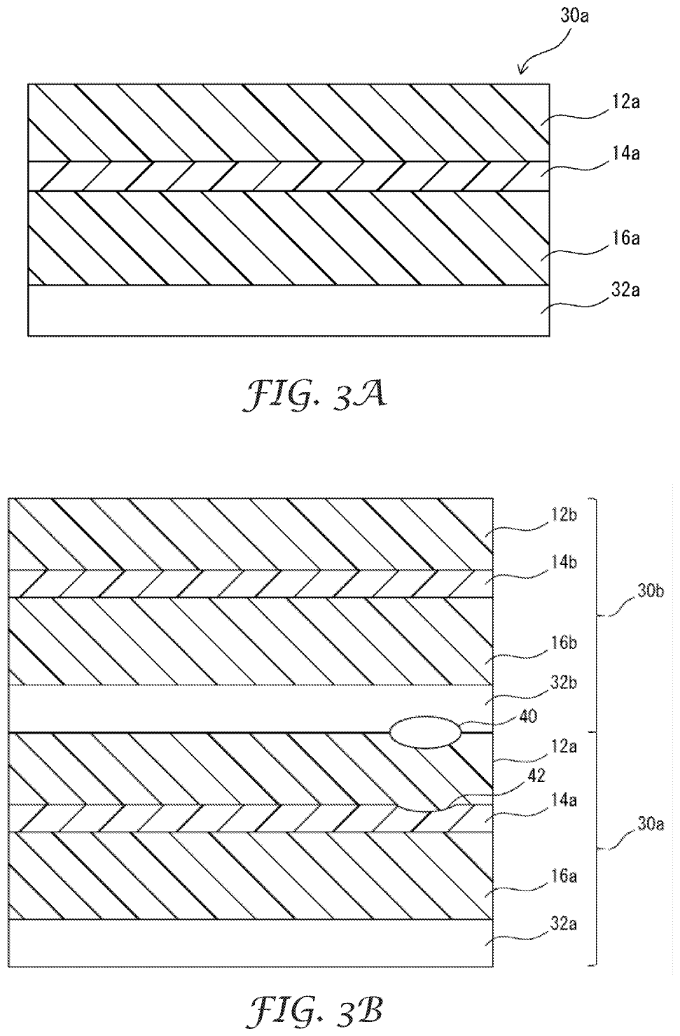

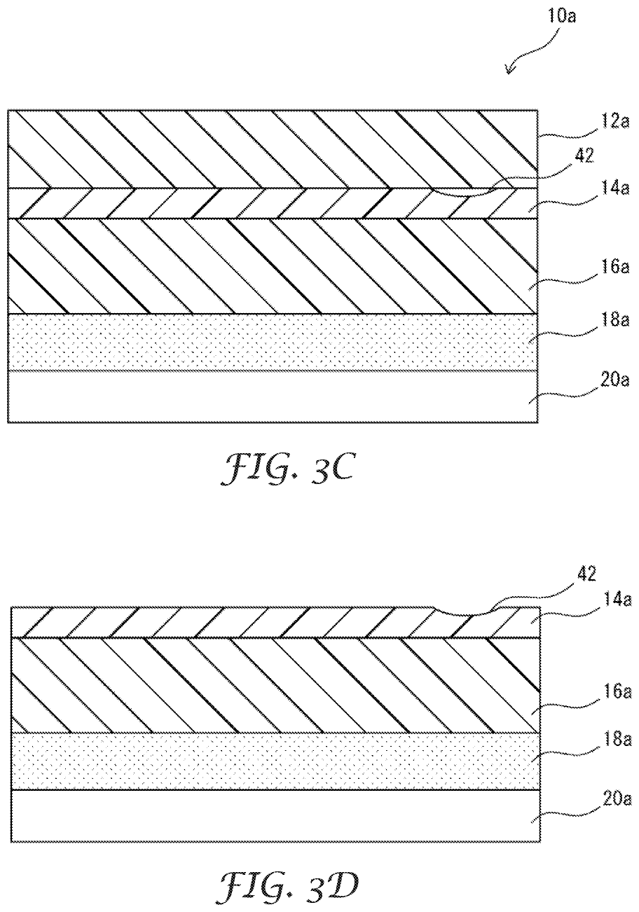

In an embodiment, the base layer has a multilayer structure including a decorative layer. In the decorative film with a cover film 10 of another embodiment illustrated in FIG. 2, the base layer 16 has a multilayer structure including a base film 162 and a decorative layer 164.

The resin film described above for the base layer can be used as the base film. A thickness of the base film is preferably approximately 10 μm or greater and approximately 500 μm or less, more preferably approximately 30 μm or greater and approximately 300 μm or less, even more preferably approximately 80 μm or greater and approximately 200 μm or less.

Examples of the decorative layer include a coloring layer (color layer), a pattern film (design film), and a metallic layer. Specifically, the decorative layer can be a layer, coating, film, or metal vapor deposition film that imparts a metallic appearance (metallic, silver metallic, or the like), a car outer plate painting color (painting color such as metallic, white pearl, pearl mica, or solid), a pattern, a logo, a picture, or the like to the decorative film.

In an embodiment, the decorative layer is a coloring layer. The coloring layer generally contains a binder resin and a colorant.

Examples of the binder resin include acrylic resins, polyurethanes, polyvinyl chlorides, and polyesters. The binder resin preferably includes a thermoplastic resin, and more preferably includes a thermoplastic acrylic resin. In this embodiment, the decorative film can be mounted to an article having a curved surface manually, with the use of a vacuum/air pressure molding (Dual Vacuum Thermoforming [DVT]) method or a vacuum molding (Vacuum Thermoforming [VT]) method with excellent shape conformability.

The colorant is the same as described for the colored base layer. A content of the colorant can be approximately 1 mass % or greater, approximately 2 mass % or greater, or approximately 5 mass % or greater, and approximately 80 mass % or less, approximately 75 mass % or less, or approximately 67 mass % or less, based on the mass of the coloring layer.

For example, the coloring layer can be formed by coating a coloring layer composition containing a binder resin, a colorant and optionally a solvent onto the base film through knife coating, bar coating, blade coating, doctor coating, roll coating, cast coating, gravure coating, or the like, and heating the composition, as necessary.

The coloring layer may have a variety of thicknesses, but generally has a thickness of approximately 1 μm or greater, approximately 10 μm or greater, or approximately 20 μm or greater, and approximately 100 μm or less, approximately 80 μm or less, or approximately 60 μm or less. Adjusting the thickness of the coloring layer to approximately 10 μm or more facilitates masking of a base color and provides a desired decorative appearance. When the paint replacement film is required to have good shape conformability, the coloring layer is advantageously thinner, and desirably, for example, approximately 80 μm or less or approximately 60 μm or less.

A thickness of the base layer is preferably approximately 10 μm or greater and approximately 500 μm or less, more preferably approximately 30 μm or greater and approximately 300 μm or less, even more preferably approximately 80 μm or greater and approximately 200 μm or less. In a case where the decorative film is used at a lower side of a side surface of a car or a front surface of a car, considering resistance against flying debris, the thickness of the base layer is preferably approximately 80 μm or greater. Except for a case of temporarily providing the decorative film as a protective tape on the surface of an adherent body, the thickness of the base layer is preferably approximately 30 μm or greater, because the film is less likely to develop wrinkles when it is attached to a curved surface. When the decorative film is excessively thick, the decorative film may lose conformability to curved surfaces, and also from the perspective of economic efficiency, the thickness of the base layer is preferably approximately 300 μm or less. If the base layer has a multilayer structure, the thickness of the base layer means a total thickness of the respective layers.

The adhesive layer contains a commonly used acrylic, polyolefin-based, polyurethane-based, polyester-based, rubber-based, silicone-based, or vinylacetate-based adhesive. In general, the adhesive layer can be formed using a solvent-type, emulsion-type, pressure-sensitive, heat-sensitive, heat-curable, or ultraviolet-curable adhesive composition. The adhesive layer may be a pressure sensitive adhesive layer.

The adhesive layer may contain an achromatic pigment such as a white pigment, a black pigment, or a mixture thereof, a chromatic pigment such as a yellow pigment, a red pigment, a green pigment, a blue pigment, or an orange pigment, or a combination thereof. The adhesive layer containing a white pigment also functions as a masking layer that masks an adherent body surface (base). As the white pigment, titanium dioxide is preferably used because of the high whiteness.

The adhesive layer can be formed using the adhesive composition. Specifically, the adhesive composition can be coated onto the second surface of the base layer and heated as necessary to form an adhesive layer. Alternatively, the adhesive composition can be coated onto another liner and heated as necessary to form an adhesive layer, and the adhesive layer can be transferred and laminated over the second surface of the base layer. For example, the adhesive layer can be formed by coating the adhesive composition to the base layer or the liner through knife coating, bar coating, blade coating, doctor coating, roll coating, cast coating, or the like, and heating the composition, as necessary. The liner may have a surface subjected to release-liner treatment with silicone or the like.

The adhesive layer may have a variety of thicknesses, but generally has a thickness of approximately 5 μm or greater, approximately 10 μm or greater, or approximately 20 μm or greater, and approximately 100 μm or less, approximately 80 μm or less, or approximately 50 μm or less. For the adhesive layer to conform to shapes of recesses and protrusions of the adherent body surface and to achieve a high adhesive force that is unlikely to cause peeling, the thickness of the adhesive layer is preferably approximately 20 μm or greater. In order to mitigate the phenomenon of the adhesive protruding at an end of the decorative film caused by the film shrinkage under high-temperature environments after the decorative film has been stretched and attached, the thickness of the adhesive layer is preferably approximately 50 μm or less.

The decorative film may have a liner that protects the adhesive layer. Examples of the liner include papers, plastic materials such as polyethylenes, polypropylenes, polyesters, and cellulose acetates, and papers coated with such plastic materials. These liners may have a surface that has been subjected to release-liner treatment with silicone or the like. A thickness of the liner is typically approximately 5 μm or greater, approximately 15 μm or greater, or approximately 25 μm or greater, and approximately 300 μm or less, approximately 200 μm or less, or approximately 150 μm or less.

The adhesive layer generally forms a flat adhesive surface, but may also form an adhesive surface with recesses and protrusions. The adhesive surface with recesses and protrusions include an adhesive surface of the adhesive layer, in which the protrusions containing the adhesive and the recesses surrounding the protrusions are formed, and when the adhesive surface is attached to an adherent body, a communicating passage is formed between the adherent body surface and the adhesive surface, the communicating passage being defined by the recesses and being in communication with the external space. An example of the method for forming the adhesive surface with recesses and protrusions will be described below.

A liner with a release surface including a predetermined recess-and-protrusion structure is prepared. The adhesive composition is coated to the release surface of the liner, and as necessary, heated to form an adhesive layer. By this, the recess-and-protrusion structure (negative structure) of the liner is transferred to the face that is in contact with the liner of the adhesive layer (this serves as the adhesive surface in the decorative film), and an adhesive surface having recesses and protrusions having the prescribed structure (positive structure) is formed on the adhesive surface. As described above, the recesses and protrusions of the adhesive surface are designed in advance to include a groove that allows formation of the communicating passage when the protrusions adhere to the adherent body.

For the groove of the adhesive layer, as long as air bubbles are prevented from remaining when the decorative film is attached to an article, the groove having a consistent shape may be arranged at the adhesive surface in accordance with a regular pattern to form a regularly-patterned groove, or the groove having an indeterminate shape may be arranged to form an irregularly-patterned groove. In a case where multiple grooves are formed to be disposed substantially parallel to each other, the interval at which the grooves are disposed is preferably from 10 to 2000 μm. The depth of the grooves (distance from the adhesive surface to the bottom of the groove measured in the direction toward the base layer) is typically approximately 10 μm or greater, and approximately 100 μm or less. The shape of the groove is also not particularly limited, as long as the effect of the present invention is not impaired. For example, the shape of the groove may be substantially rectangular (including trapezoidal), substantially semi-circular, or substantially semi-elliptical at a cross-section of the groove in a direction perpendicular to the adhesive surface.

The decorative film with a cover film can be manufactured, for example, by a method including the following steps:
(a) providing a base layer having a first surface and a second surface opposite to the first surface;
(b) forming a polyurethane layer on the first surface of the base layer, the polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane, and the first surface of the base layer is in contact with the second surface of the polyurethane layer;
(c) providing a removable cover film;
(d) treating a surface of the removable cover film with corona or plasma;
(e) laminating the removable cover film over the polyurethane layer such that the corona treated or plasma treated surface of the removable cover film contacts the first surface of the polyurethane layer; and
(f) forming an adhesive layer on the second surface of the base layer to obtain a decorative film with a cover film.

The above material can be used as the base layer provided in step (a). The base layer may be provided with a process film as a support on its second surface.

The formation of the polyurethane layer in step (b) can be performed as described above. The polyurethane contained in the polyurethane layer is at least partially crosslinked. At the completion of step (b), the polyurethane is preferably not completely crosslinked. In this embodiment, in step (e), the removable cover film can be firmly adhered to the polyurethane layer.

The above material can be used as the removable cover film of step (c).

The corona treatment or plasma treatment of step (d) can be performed as described above. In an embodiment, the corona treatment or plasma treatment is performed such that the surface tension of the surface of the removable cover film is approximately 40 mN/m or greater. After completion of the corona treatment or plasma treatment, step (e) is carried out within preferably within 1 hour, more preferably within 10 minutes. More preferably, step (d) and step (e) are performed as a continuous process.

The lamination of the removable cover film in step (e) is preferably performed before the polyurethane is completely crosslinked. By laminating the removable cover film in a state where the polyurethane is partially crosslinked, the removable cover film can be firmly adhered to the polyurethane layer.

In an embodiment, when the removable cover film is stored at 23° C. for 48 hours after step (e), and thereafter peeled from the polyurethane layer, a peel strength of the removable cover film is from approximately 0.15 to approximately 2.0 N/50 mm. The peel strength is determined under the same conditions as those used in the method for measuring the peel strength of the decorative film with a cover film described in the Examples.

The peel strength measured after storing at 23° C. for 48 hours after step (e) can be utilized as an index indicating an extent of a crosslinking reaction of the polyurethane contained in the polyurethane layer formed in step (b) at the time of completion of step (c). Specifically, when the crosslinking reaction of the polyurethane is in an initial stage, low cohesive force inside the polyurethane layer causes occurrence of cohesive failure of the polyurethane layer, instead of interfacial peeling between the polyurethane layer and the removable cover film. This results in an apparent peel strength being measured low. As the crosslinking reaction of the polyurethane proceeds, the cohesive force inside the polyurethane layer exceeds interfacial peel strength between the polyurethane layer and the removable cover film, thereby causing interfacial peeling between the polyurethane layer and the removable cover film. However, the inside and surface of the polyurethane layer are still soft and the surface of the polyurethane layer is too tacky, and thus the peel strength is measured high. As the crosslinking reaction of the polyurethane further proceeds, the peel strength decreases along with a decrease in tackiness of the surface of the polyurethane layer. At this time, the surface of the polyurethane layer has enough tackiness to allow a corona-treated or plasma-treated cover film to adhere well, and the hardness of the polyurethane layer is increased to such an extent that surface defects such as craters can be suppressed. As the polyurethane approaches a completely crosslinked state, the peel strength further decreases, and the removable cover film does not adhere to the surface of the polyurethane layer with sufficient force.

The material and formulation of the polyurethane layer composition, the conditions for forming the polyurethane layer in step (b), and the conditions for the corona treatment or plasma treatment in step (d) are selected such that the peel strength is in a range from approximately 0.15 to approximately 2.0 N/50 mm, thereby making it possible to ensure the adhesion of the removable cover film to the polyurethane layer while appropriately increasing the hardness of the polyurethane layer. As a result, it is possible to suppress the occurrence of surface defects such as craters in the polyurethane layer, and prevent the removable cover film from falling off during manufacture, transportation and use of the decorative film with a cover film.

The formation of the adhesive layer in step (f) can be performed as described above. A decorative film with a cover film may be obtained with a release liner that covers the adhesive layer.

The method for manufacturing a decorative film with a cover film may optionally further include the following step (g):
(g) winding the decorative film with a cover film into a roll after forming the adhesive layer.

In step (g), the decorative film with a cover film can be wound around a core using a winding device used in normal film manufacture. In this embodiment, the decorative film with a cover film can be stored and transported in a roll form without deteriorating the surface quality of the decorative film.

In an embodiment, the decorative film is manufactured by incorporating the following step (h) after step (f):
(h) removing the removable cover film from the first surface of the polyurethane layer.

Step (h) involves peeling the cover film continuously with a winding device or manually peeling the cover film from the cut decorative film.

A total thickness of the decorative film, excluding the thicknesses of the cover film and the liner, can be approximately 25 μm or greater, approximately 80 μm or greater, or approximately 150 μm or greater, and approximately 600 μm or less, approximately 400 μm or less, or approximately 350 μm or less.

In an embodiment, the peel strength of the removable cover film in the decorative film with a cover film is approximately 0.15 N/50 mm or greater, approximately 0.2 N/50 mm or greater, approximately 0.25 N/50 mm or greater, approximately 1.0 N/50 mm or less, approximately 0.8 N/50 mm or less, or approximately 0.5 N/50 mm or less. The peel strength is determined by the method described in the Examples.

The decorative film with a cover film may be in the form of a wound roll. In this embodiment, the surface quality of the decorative film can be maintained even when air is trapped between two decorative films overlapped by winding.

A method for mounting a decorative film of an embodiment includes applying the decorative film with a cover film to a substrate; and thereafter, removing the removable cover film from the first surface of the polyurethane layer. In this embodiment, because the polyurethane layer is protected by the removable cover film, the decorative film can be firmly adhered to the substrate by pressing the decorative film onto the substrate from above the removable cover film using a crimping jig or the like while maintaining the surface quality of the decorative film.

A method for mounting a decorative film of another embodiment includes removing the removable cover film of the decorative film with a cover film from the first surface of the polyurethane layer to obtain a decorative film, and applying the decorative film to a substrate. In this embodiment, by removing the removable cover film before application of the decorative film, the decorative film can exhibit the shape conformability inherent in the decorative film. Therefore, the decorative film can be applied with excellent shape conformability to a substrate having a three-dimensional surface such as a corner portion, a curved surface, or a concave-convex shape.

The decorative film of the present disclosure can be suitably used as a paint replacement film. For example, the decorative film according to the present disclosure can be applied to a body (including a roof, a door, a hood, and the like) of a vehicle or a part of the body, or to a constituent part (for example, a bumper, a roof molding, a side guard mold, a pillar, and the like) of a vehicle. Examples of the vehicles include: cars such as trucks, buses, and passenger cars: two-wheeled vehicles such as motorcycles and motor scooters: bicycles: trains; and ships such as pleasure boats, yachts, and motorboats.

### EXAMPLES

In the following examples, specific embodiments of the present disclosure will be illustrated, but the present invention is not limited to these examples. All ‘part’ and ‘percent’ are based on mass unless otherwise specified. A numerical value essentially includes an error originated from a measurement principle and a measuring device. The numerical value is generally indicated by a significant digit that is rounded.

Raw materials used in a polyurethane layer composition of examples are shown in the following Table 1.

TABLE 1

| Trade name, | | |
|---|---|---|
| model number, | | |
| or abbreviated | | |
| name | Description | Manufacturer |
| PLACCEL | Polycaprolactone diol | Daicel Corporation |
| 205H | (polyester diol) | (Osaka-shi, Osaka, Japan) |
| Nippolan | Polycarbonate diol | Tosoh Corporation |
| 983 | | (Minato-ku, Tokyo, Japan) |
| Tinuvin | Hindered amine light | BASF Japan Ltd. |
| (trade name) | stabilizer | (Chuo-ku, Tokyo, Japan) |
| 292 | | |
| Tinuvin | Benzotriazole-based | BASF Japan Ltd. |
| (trade name) | UV absorber | (Chuo-ku, Tokyo, Japan) |
| 99-2 | | |
| ACAC | Acetylacetone | Kanto Chemical Co., Inc. |
| | | (Chuo-ku, Tokyo, Japan) |
| DBTDL | Dibutyltin (IV) | FUJIFILM Wako Pure Chemical |
| | dilaurate | Corporation |
| | | (Osaka-shi, Osaka, Japan) |
| Butyl acetate | Butyl acetate | Daicel Corporation |
| | | (Osaka-shi, Osaka, Japan) |
| Acrit UA702 | Leveling agent, acrylic | Taisei Fine Chemical Co., Ltd. |
| | polyol | Asahi-shi, Chiba, Japan) |
| VEATANAT | Isophorone | Evonik Industries AG |
| (trade name) | diisocyanate trimer | (Essen, Nordrhein-Westfalen, |
| T1890E | | Germany) |

### Comparative Example 1

A decorative film with a cover film of Comparative Example 1 was produced by the following procedure.

(1) A base layer having a multilayer structure including a coloring layer and a base film was produced by coating a black pigment-containing acrylic composition having the composition shown in Table 2 onto a thermoplastic polyurethane film with a thickness of 150 μm (Sheedom Co., Ltd., Osaka-shi, Osaka, Japan) supported by a polypropylene film with a thickness of 80 μm as a process film, and heating the composition in a continuous oven at 80° C. for 5 minutes to form a coloring layer with a dry thickness of 23 μm on the thermoplastic polyurethane film.

TABLE 2

| Component | Blending ratio (mass %) |
|---|---|
| Acrylic resin | 27.45 |
| Carbon black | 1.00 |
| Cellulose acetate butyrate | 4.95 |
| Isophorone diisocyanate | 4.26 |
| Propylene glycol monomethyl ether acetate | 8.36 |
| Xylene | 12.21 |
| Ethyl benzene | 7.23 |
| Isobutyl acetate | 8.17 |
| Butyl acetate | 15.57 |
| Ethyl acetate | 5.45 |
| Methyl isobutyl ketone | 5.35 |

(2) A polyurethane layer composition having a solid content of 76.5 mass % prepared according to the composition shown in Table 3 was coated to the coloring layer side of the base layer formed in (1) and heated for 3 minutes 20 seconds in a continuous oven at 80° C.; a polyurethane layer with a dry thickness of 25 μm containing a polyester-based polyurethane and polycarbonate-based polyurethane which were crosslinked at least partially was formed.

TABLE 3

| | Solid content | Blending ratio |
|---|---|---|
| | (mass %) | (mass %) |
| PLACCEL 205H | 100 | 19.8 |
| Nippolan 983 | 100 | 19.8 |
| Tinuvin (trade name) 292 | 100 | 1.0 |
| Tinuvin (trade name) 99-2 | 95 | 2.0 |
| ACAC | — | 3.0 |
| DBTDL | 100 | 0.02 |
| Butyl acetate | — | 4.6 |
| Acrit UA702 | 51 | 4.6 |
| VEATANAT (trade name) | 70 | 45.3 |
| T1890E | | |

(3) Immediately after formation of the polyurethane layer, a polyethylene terephthalate cover film with a thickness of 50 μm was laminated over a surface of the polyurethane layer.

(4) An acrylic pressure-sensitive adhesive containing 2-ethylhexyl acrylate and acrylic acid was coated onto a silicone coated polyethylene terephthalate release liner and heated in a continuous oven at 80° C. for 5 minutes to form a pressure-sensitive adhesive layer with a dry thickness of 35 μm.

(5) The process film was removed from the laminate formed in (3), and a base film side of the base layer and the pressure-sensitive adhesive layer formed in (4) were laminated so as to come into contact with each other to produce a decorative film with a cover film.

### Comparative Example 2

A decorative film with a cover film was produced using the same procedure as in Comparative Example 1 with the exception that the heating time in the continuous oven was changed to 8 minutes to 20 seconds when the polyurethane layer was formed.

### Example 1

A decorative film with a cover film was produced using the same procedure as in Comparative Example 2 with the exception that the polyethylene terephthalate cover film was plasma treated under the following conditions immediately before lamination.
Plasma treatment apparatus: AP-T04-R1400 (Sekisui Chemical Co., Ltd., Osaka-shi, Osaka, Japan)
N₂ Flow rate: 100 L/min
Voltage: 360 V
Current: 3.5 A

### Example 2

A decorative film with a cover film was produced using the same procedure as in Comparative Example 2 with the exception that the polyethylene terephthalate cover film was corona treated under the following conditions immediately before lamination.
Corona treatment apparatus: GX50R (Sherman Treaters Ltd., Thame, Oxfordshire, England)
Output power: 2 kW

### Example 3

A decorative film with a cover film of Example 3 was produced by the same procedure as in Example 2.

### Example 4

A decorative film with a cover film was produced using the same procedure as in Example 2 with the exception that the output power of the corona treatment was changed to 3 kW.

### Surface Quality (Crater Defect)

After removal of the cover film from each of the decorative films with a cover film of Examples 1 to 4 and Comparative Examples 1 and 2, the number of craters having a size of 0.3 mm² or greater was counted visually, as compared with the dirt comparison chart (manufactured by National Printing Bureau, and sold by Choyokai Co., Ltd., Soka-shi, Saitama, Japan).

### Peel Strength

A sample was prepared by cutting the decorative film with a cover film into a width of 50 mm and a length of 200 mm. The cover film was subjected to 180 degree peel using Autograph AGS-X 500N (Shimadzu Corporation, Kyoto-shi, Kyoto, Japan) at room temperature (23° C.) and a peeling speed of 200 mm/min. An average of the measured values obtained by two measurements was taken as peel strength (N/50 mm).

### Surface Tension

The surface tension was evaluated using an aqueous surface tension reagent, EnerDyne (trade name) Pen (Enercon Industries Corp., Menomonee Falls, Wisconsin, USA).

Details and evaluation results of the decorative films with a cover film of Examples 1 to 4 and Comparative Examples 1 and 2 are shown in Table 4. The number of days after lamination in Table 4 means the number of days after lamination of the cover film at which the surface tension and the peel strength were measured.

TABLE 4

| | | Cover film | | | |
|---|---|---|---|---|---|
| | | | Surface tension | | |
| | Polyurethane | | Exposed | Laminated | After |
| | layer | Surface | surface | surface | lamination |
| | Heating time | treatment | [mN/m] | [mN/m] | [Day] |
| Comparative | 3 min 20 sec | No | N.A. | N.A. | N.A. |
| Example 1 | | | | | |
| Example 1 | 8 min 20 sec | Plasma treatment | 35 | 48 | 269 |
| Example 2 | 8 min 20 sec | Corona treatment | 38 | 56 | 2 |
| | | 2 kW | | | |
| Example 3 | 8 min 20 sec | Corona treatment | 38 | 48 | 69 |
| | | 2 kW | | | |
| Example 4 | 8 min 20 sec | Corona treatment | 38 | 48 | 282 |
| | | 3 kW | | | |
| Comparative | 8 min 20 sec | No | N.A. | N.A. | 104 |
| Example 2 | | | | | |

| | Decorative film with cover film | | | | |
|---|---|---|---|---|---|
| | Surface | | Number of | | |
| | quality | Peel | days after | | |
| | [number of | strength | lamination | Peeling | |
| | craters/m²] | [N/50 mm] | [Day] | behavior | Peelability |
| Comparative | 400 | 0.18 | 546 | Smooth | PASS |
| Example 1 | | | | | |
| Example 1 | 15 | 0.19 | 276 | Zipping | PASS |
| Example 2 | 15 | 0.93 | 6 | Zipping | Acceptable |
| | | 0.48 | 13 | Zipping | PASS |
| | | 0.31 | 22 | Zipping | PASS |
| Example 3 | N.A. | 0.33 | 63 | Zipping | PASS |
| Example 4 | N.A. | 0.20 | 276 | Zipping | PASS |
| Comparative | 30 | 0.10 | 104 | Smooth | Cover film fell |
| Example 2 | | | | | off during steps. |

Various variations of the above-mentioned embodiments and examples will be apparent to those skilled in the art without departing from the basic principle of the present invention. In addition, various modifications and variations of the present invention will be apparent to those skilled in the art without departing from the spirit and scope of the present invention.

### REFERENCE SIGNS LIST

10, 10a: Decorative film with cover film
12, 12a, 12b: Removable cover film
122: Corona treated or plasma treated surface
14, 14a, 14b: Polyurethane layer
16, 16 a, 16b: Base layer
162: Base film
164: Decorative layer
18, 18a: Adhesive layer
20, 20a: Liner
30a, 30b: Intermediate member
32a, 32b: Process film
40: Air
42: Crater

1. A decorative film with a cover film comprising:
(a) a polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane;
(b) a removable cover film having a corona treated or plasma treated surface, wherein the corona treated or plasma treated surface of the removable cover film is in contact with the first surface of the polyurethane layer;
(c) a base layer having a first surface and a second surface opposite to the first surface, wherein the first surface of the base layer is in contact with the second surface of the polyurethane layer; and
(d) an adhesive layer in contact with the second surface of the base layer.

2. The decorative film with a cover film according to claim 1, wherein a surface tension of the corona treated or plasma treated surface of the removable cover film is 40 mN/m or greater.

3. The decorative film with a cover film according to claim 1, wherein a peel strength of the removable cover film is from 0.15 to 1.0 N/50 mm.

4. The decorative film with a cover film according to claim 1, wherein a surface tension of a surface of the removable cover film opposite to the corona treated or plasma treated surface is less than 40 mN/m.

5. The decorative film with a cover film according to claim 1, wherein the removable cover film is a polyethylene terephthalate film.

6. The decorative film with a cover film according to claim 1, wherein the base layer include at least one thermoplastic resin selected from the group consisting of a polyurethane, a polyvinyl chloride, a polyolefin, an acrylic resin, and a polyester.

7. The decorative film with a cover film according to claim 1, wherein the base layer has a multilayer structure including a decorative layer.

8. A roll comprising the decorative film with a cover film described in claim 1 which has been wound.

9. A method for manufacturing a decorative film with a cover film, comprising:
(a) providing a base layer having a first surface and a second surface opposite to the first surface;
(b) forming a polyurethane layer on the first surface of the base layer, the polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane, and the first surface of the base layer is in contact with the second surface of the polyurethane layer;
(c) providing a removable cover film;
(d) treating a surface of the removable cover film with corona or plasma;
(e) laminating the removable cover film over the polyurethane layer such that the corona treated or plasma treated surface of the removable cover film contacts the first surface of the polyurethane layer; and
(f) forming an adhesive layer on the second surface of the base layer to obtain a decorative film with a cover film.

10. The method according to claim 9, wherein the surface of the removable cover film is treated with corona or plasma such that a surface tension of the surface of the removable cover film is 40 mN/m or greater.

11. The method according to claim 9, wherein, when the removable cover film is stored at 23° C. for 48 hours after the step (e), and thereafter peeled from the polyurethane layer, a peel strength of the removable cover film is from 0.15 to 2.0 N/50 mm.

12. The method according to claim 9, wherein the removable cover film is a polyethylene terephthalate film.

13. The method according to claim 9, further comprising (g) winding the decorative film with a cover film into a roll after forming the adhesive layer.

14. A method for manufacturing a decorative film, comprising:
(a) providing a base layer having a first surface and a second surface opposite to the first surface;
(b) forming a polyurethane layer on the first surface of the base layer, the polyurethane layer having a first surface and a second surface opposite to the first surface and containing a polyurethane that is crosslinked at least partially, wherein the polyurethane that is crosslinked at least partially includes at least one of a polyester-based polyurethane or a polycarbonate-based polyurethane and the first surface of the base layer is in contact with the second surface of the polyurethane layer;
(c) providing a removable cover film;
(d) treating a surface of the removable cover film with corona or plasma;
(e) laminating the removable cover film over the polyurethane layer such that the corona treated or plasma treated surface of the removable cover film contacts the first surface of the polyurethane layer;
(f) forming an adhesive layer on the second surface of the base layer; and
(h) removing the removable cover film from the first surface of the polyurethane layer.

15. The method according to claim 14, wherein the surface of the removable polyethylene terephthalate cover film is treated with corona or plasma such that a surface tension of the surface of the removable cover film is 40 mN/m or greater.

16. The method according to claim 14, wherein, when the removable cover film is stored at 23° C. for 48 hours after the step (e), and thereafter peeled from the polyurethane layer, a peel strength of the removable cover film is from 0.15 to 2.0 N/50 mm.

17. A method for mounting a decorative film, comprising:
applying the decorative film with a cover film described in claim 1 to a substrate; and
thereafter, removing the removable cover film from the first surface of the polyurethane layer.

18. A method for mounting a decorative film, comprising:
removing the removable cover film of the decorative film with a cover film described in claim 1 from the first surface of the polyurethane layer to obtain a decorative film; and
applying the decorative film to a substrate.
